(19) United States
(12) Patent Application Publication
(10) Pub. No.: US 2009/0165747 A1
(43) Pub. Date: Jul. 2, 2009

(54) Two-Stroke Engine

(75) Inventors: Takayoshi Shimazaki, Saitama (JP); Syouta Takeshima, Saitama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Husgvarna Zenoah Co., Ltd, Kagagoe-shi (JP)

(21) Appl. No.: 12/226,290

(22) PCT Filed: Apr. 17, 2007
(86) PCT No.: PCT/JP2007/058343

§ 371 Date: Oct. 14, 2008

(30) Foreign Application Priority Data
Apr. 17, 2006 (JP) 2006-113718

(51) Int. Cl. F02P 5/00

(52) U.S. Cl. 123/406.58

(57) ABSTRACT

A two-stroke engine includes an ignition module that receives a detection signal from a magnetic sensor for detecting a permanent magnet and transmits an ignition signal to an ignition plug. The permanent magnet is provided at a single position on a flange that rotates synchronously with the magnetic sensor. The magnetic sensor is attached to one of sensor attachments and provided at two positions adjacent to the engine body. The sensor attachments and are so provided as to correspond to a rotational direction of the engine. With such an arrangement, the permanent magnet is less affected by noise because the permanent magnet is disposed at only one position. By changing a position at which the sensor is attached, the engine having common components is enabled to work in the same manner during both of normal rotation and reverse rotation.

### TECHNICAL FIELD

The present invention relates to a two-stroke engine, and more particularly to a two-stroke engine rotatable in both of a normal rotational direction and a reverse rotational direction.

### BACKGROUND ART

The following arrangement has been known to cause a discharge on an ignition plug in a two-stroke engine.

Specifically, such a known arrangement includes a detected unit for detecting a rotational position (specifically a permanent magnet) provided on a rotor that rotates in synchronization with the rotation of the engine and an ignition coil provided opposite to the permanent magnet. When the permanent magnet passes near the ignition coil in accordance with the rotation of the rotor, the ignition coil produces an electromotive force. Then, the electromotive force is supplied to cause a discharge on the ignition plug.

To appropriately operate the engine, it is necessary to cause a discharge on the ignition plug at an appropriate timing, specifically at a predetermined timing prior to a timing when a piston reaches a top dead center. Therefore, as viewed from a position at which the ignition coil is provided, the permanent magnet is provided on the rotor at such a position that is spaced apart by a predetermined angle in a direction reverse to a rotational direction from the top dead center of the piston, at which the piston faces the ignition coil.

Recently, upon increased demand for a downsized engine, a magnetic sensor has been typically used in place of the ignition coil to cause a discharge on the ignition plug by a battery in accordance with a detection signal generated when the magnetic sensor detects the permanent magnet.

On the other hand, in engines mounted on a two-engine aircraft of a radio-controlled aircraft, it is necessary that a right engine and a left engine are rotated reversely to each other in order to offset reaction of the engines.

However, when an engine in which an appropriate ignition timing is adjusted for rotating in one direction as described above is simply rotated reversely, the permanent magnet is detected after the piston reaches the top dead center. Accordingly, a discharge on the ignition plug cannot be caused at the appropriate timing.

Thus, a method has been suggested for causing a discharge on the ignition plug at an appropriate timing even when the engine is reversely rotated (for example, see Patent Document 1).

Patent Document 1 discloses that detected units for detecting a rotational position (more specifically, teeth protruding radially and outwardly from the rotor) are provided at two positions that are respectively spaced apart by a predetermined angle forwardly and backwardly in a rotational direction of the rotor from a predetermined position in the rotor, the predetermined position facing the sensor when the piston is on the top dead center. With such an arrangement, a discharge is caused on the ignition plug at an appropriate timing in both of normal rotation and reverse rotation.

Patent Document 1: JP-A-2002-242809

### DISCLOSURE OF THE INVENTION

### Problems to be Solved by the Invention

However, the method disclosed in Patent Document 1 has a problem that a signal outputted from the sensor is often erroneously detected because the ignition plug is controlled by processing a plurality of signals outputted when the teeth are respectively detected.

An object of the present invention is to provide a two-stroke engine capable of causing a discharge on an ignition plug at an appropriate timing when being rotated either normally or reversely, and accurately detecting a signal outputted from a sensor.

### Means for Solving the Problems

A two-stroke engine according to an aspect of the invention includes: a detected unit for detecting a rotational position that is provided on a rotor that rotates synchronously with a rotation of the engine; a sensor that is attached adjacent to an engine body and adapted to detect the detected unit for detecting the rotational position; and an ignition timing controller that receives a detection signal from the sensor and transmits an ignition signal to an ignition plug, in which the detected unit for detecting the rotational position is provided at a single position of the rotor, sensor attachments are provided at two positions adjacent the engine body, and the sensor is attached to one of the sensor attachments.

According to the aspect of the invention, the signal outputted from the sensor is accurately detectable without being erroneously detected because the detected unit for detecting the rotational position is disposed at only one position of the rotor. Since the sensor attachments are disposed at two positions adjacent to the engine body, the engine having common components is capable of working in the same manner when being rotated either normally or reversely by changing a position of the sensor in accordance with a rotational direction of the engine. In both of normal rotation or reverse rotation, a discharge can be caused on the ignition plug at a predetermined timing before a piston reaches the top dead center.

It is preferable that the sensor attachments adjacent to the engine body are respectively positioned at a position at which an appropriate ignition timing when the engine is rotated in a predetermined direction is detectable by the sensor and at a position at which an appropriate ignition timing when the engine is rotated in a reverse direction of the predetermined direction is detectable by the sensor.

With this arrangement, the sensor attachments are provided at such a position that allows the appropriate timings to be detected during the normal rotation and the reverse rotation of the engine. Therefore, a discharge can be caused on the ignition plug at the appropriate timing.

It is preferable that the sensor attachments adjacent to the engine body are respectively positioned: at a lower side of a crankcase provided to the engine when the engine body is disposed such that a cylinder is positioned on an upper side; and adjacent to a lateral of the crankcase and spaced apart from a muffler.

With this arrangement, thermal effect transmitted from the cylinder and the muffler to the sensor can be reduced as compared to an arrangement in which the sensor attachments are provided adjacent to the cylinder and the muffler, thereby improving durability of the engine.

The detected unit for detecting the rotational position may be provided by a permanent magnet, and the sensor may be provided by a magnetic sensor.

The magnetic sensor can detect the rotation of the engine by detecting a magnet field of the permanent magnet without contacting the engine. Therefore, the rotation of the engine is not hampered. Further, the signal outputted from the magnetic sensor is accurately detectable even when the engine is used under a condition where the engine can be pulled with dust.

The detected unit for detecting the rotational position may be attached to a lateral of the rotor, the lateral opposing to the engine body.

With this arrangement, the signal outputted from the sensor is accurately detectable because the detected unit for detecting the rotational position can be disposed adjacent to the sensor. Further, the detected unit for detecting the rotational position is prevented from dropping from the rotor due to centrifugal force because the detected unit is attached to the lateral of the rotor.

### BRIEF DESCRIPTION OF DRAWINGS

FIG. 1 is a front view illustrating a two-stroke engine during normal rotation according to an exemplary embodiment of the invention.

FIG. 2 is a right side view illustrating the two-stroke engine during the normal rotation according to the exemplary embodiment.

FIG. 3 is a front view illustrating the two-stroke engine during reverse rotation according to the exemplary embodiment.

FIG. 4A is a schematic view illustrating the two-stroke engine when a piston is positioned on a bottom dead center according to the exemplary embodiment.

FIG. 4B is a schematic view illustrating the two-stroke engine at an appropriate ignition timing during the normal rotation according to the exemplary embodiment.

FIG. 4C is a schematic view illustrating the two-stroke engine when the piston is positioned on a top dead center according to the exemplary embodiment.

FIG. 4D is a schematic view illustrating the two-stroke engine at an appropriate ignition timing during the reverse rotation according to the exemplary embodiment.

### EXPLANATION OF CODES

1: engine body, 2: cylinder, 3: crankcase, 4: ignition plug, 5: crankshaft, 6: insulator, 7: carburetor, 8: muffler, 9: magnetic sensor, 13: propeller hub, 14: flange, 15: propeller holder, 16: ignition module, 17: battery, 31: normal-rotation sensor attachment, 32: reverse-rotation sensor attachment, 141: permanent magnet

### BEST MODE FOR CARRYING OUT THE INVENTION

An exemplary embodiment of the invention will be described below with reference to the drawings.

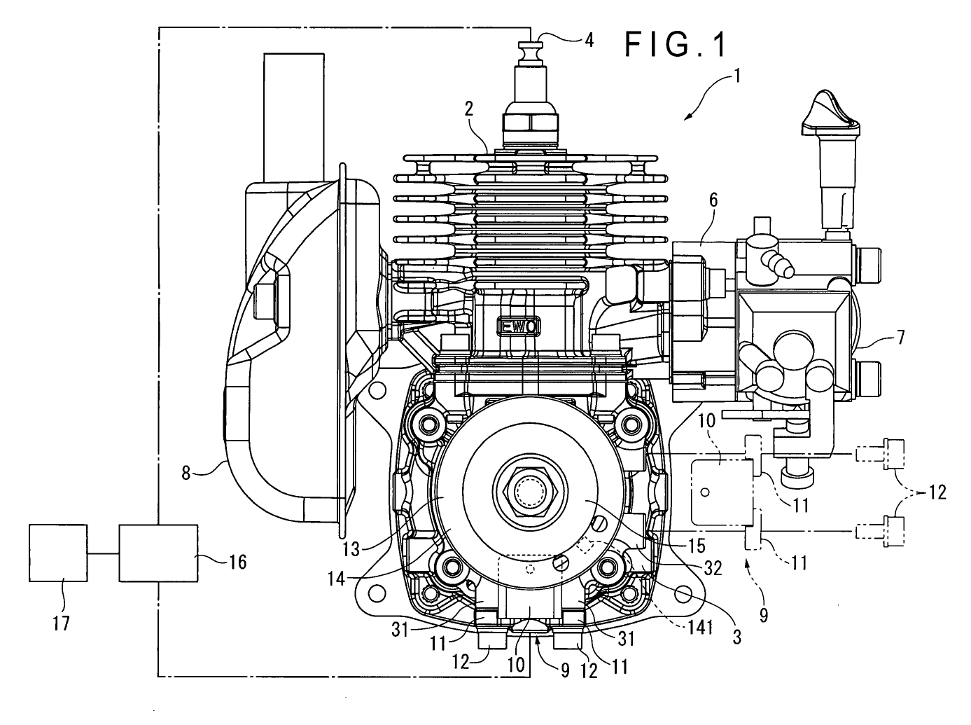

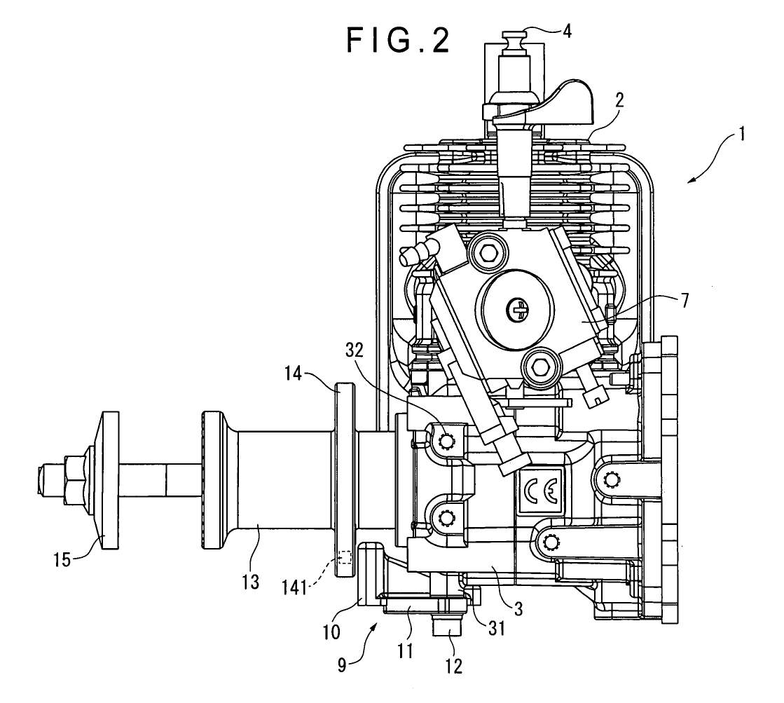

FIG. 1 is a front view and FIG. 2 is a right side view illustrating a two-stroke engine for a radio-controlled aircraft when being rotated in a predetermined direction, i.e., during latter-described normal rotation.

As shown in FIGS. 1 and 2, the two-stroke engine includes: an engine body 1; an ignition plug 4 provided on an end of the engine body 1 as shown at an upper side of FIG. 1; a later-described crankshaft 5 rotatably supported by a bearing (not shown); a carburetor 7 mounted on a lateral face of the engine body 1 through an insulator 6 as shown on the right of the FIG. 1; and a muffler 8 mounted on another lateral face of the engine body 1 as shown on the left of FIG. 1.

The engine body 1 includes a cylinder 2 having a plurality of fins and a crankcase 3 provided below the cylinder 2 as shown in FIG. 1.

Sensor attachments 31 and 32 are provided adjacent to the crankcase 3 at two positions: namely, a position at a lower side of the crankcase 3 when the engine body 1 is disposed with the cylinder 2 being positioned on an upper side; and a position adjacent to a lateral of the crankcase 3 and spaced apart from the muffler 8.

With such an arrangement, the sensor attachments 31 and 32 are spaced apart from the cylinder 2 and the muffler 8 which generate heat. Accordingly, thermal effect on a later-described magnetic sensor 9 attached to the sensor attachment 31 or 32 can be reduced, thereby improving durability of the magnetic sensor 9.

The sensor attachments 31 and 32 each have a pair of bosses protruding from the crankcase 3 and a threaded hole (not shown) formed in the pair of bosses.

The sensor attachment 31 (hereinafter referred to as a normal-rotation sensor attachment 31) on the lower side of the crankcase 3 is for enabling a sensor to detect an appropriate ignition timing when the engine is rotated in a predetermined direction (hereinafter referred to as normal rotation). The sensor attachment 32 (hereinafter referred to as a reverse-rotation sensor attachment 32) adjacent to the lateral of the crankcase 3 and spaced apart from the muffler 8 is for enabling a sensor to detect an appropriate ignition timing when the engine is rotated in a reverse direction of the predetermined direction (hereinafter referred to as reverse rotation).

The magnetic sensor 9 is attached to the normal-rotation sensor attachment 31, the magnetic sensor 9 detecting the appropriate ignition timing during the normal rotation of the two-stroke engine.

The magnetic sensor 9 includes a sensor body 10 and a collar 11 in which a sensor-attaching hole (not shown) for attaching the sensor is formed. The magnetic sensor 9 is fixed by inserting a bolt 12 into the sensor-attaching hole and by threading the threaded hole formed in the pair of bosses of the normal-rotation sensor attachment 31 or the reverse-rotation sensor attachment 32.

A propeller hub 13, which protrudes from the crankcase 3 toward the left in FIG. 2, works as a rotor that rotates in synchronization with the rotation of the two-stroke engine, i.e., the rotation of the later-described crankshaft 5.

The propeller hub 13 includes a flange 14 that is formed adjacent to the crankcase 3 and a propeller holder 15 that holds a propeller of the radio-controlled aircraft. The flange 14 is provided with a permanent magnet 141 (i.e., a detected unit for detecting a rotational position) on a lateral opposite to the engine body 1.

The flange 14 has a hole on the lateral opposite to the engine body 1. The permanent magnet 141 is fixed to the hole by an adhesive or the like. The hole is formed at such a position that the permanent magnet 141 is detectable by the magnetic sensor 6.

Since the permanent magnet 141 is fixed to the hole formed on the lateral of the flange 14, the permanent magnet 141 can be positioned adjacent to the magnetic sensor 9. Therefore, a signal outputted from the magnetic sensor 9 is accurately detectable. Further, the permanent magnet 141 is prevented from dropping from the flange 14 due to centrifugal force.

Since the flange 14 is used as the rotor to which the permanent magnet 141 is attached, no other specific component is necessary. Also, since the flange 14 has a relatively large diameter, the permanent magnet 141 can be easily detected by the magnetic sensor 9 that can be easily attached to the engine body 1.

An ignition module 16 (i.e., an ignition timing controller) is connected to the magnetic sensor 9 on the left in FIG. 1. The ignition plug 4 and a buttery 17 are connected to the ignition module 16 through a predetermined high-tension cord or a cable. The ignition module 16 receives a signal for notifying that the magnetic sensor 9 detects the passage of the permanent magnet 141, raises a voltage fed by the buttery 17 to a requisite voltage, and then supplies electricity to the ignition plug 4.

Since the permanent magnet 141 is provided at only one position of the flange 14, the signal outputted from the magnetic sensor 9 is accurately detectable.

Further, the magnetic sensor 9 can detect the rotation of the engine by detecting a magnet field of the permanent magnet 141 without contacting the engine. Therefore, the rotation of the engine is not hampered. Furthermore, the signal outputted from the magnetic sensor 9 is accurately detectable even when the engine is used under a condition where the engine can be pulled with dust.

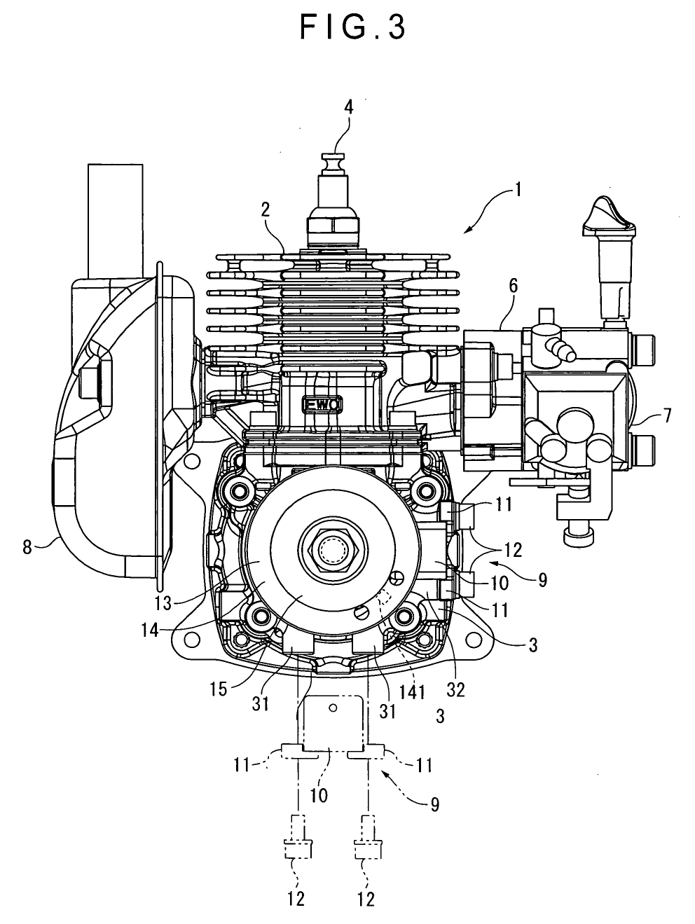

FIG. 3 is a front view illustrating the two-stroke engine for the radio-controlled aircraft according to the exemplary embodiment as shown in FIGS. 1 and 2 when the two-stroke engine is reversely rotated.

While the two-stroke engine is reversely rotated, the magnetic sensor 9 is attached to the reverse-rotation sensor attachment 32 for enabling the magnetic sensor 9 to detect the appropriate ignition timing during the reverse rotation of the two-stroke engine as shown in FIG. 3.

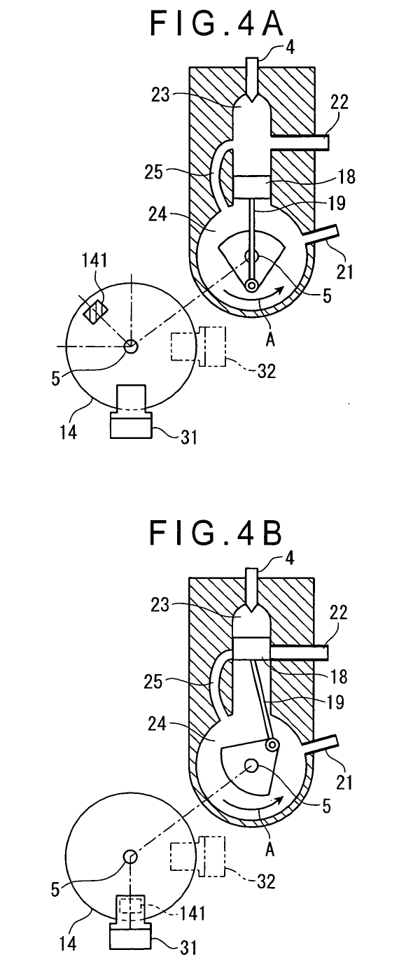

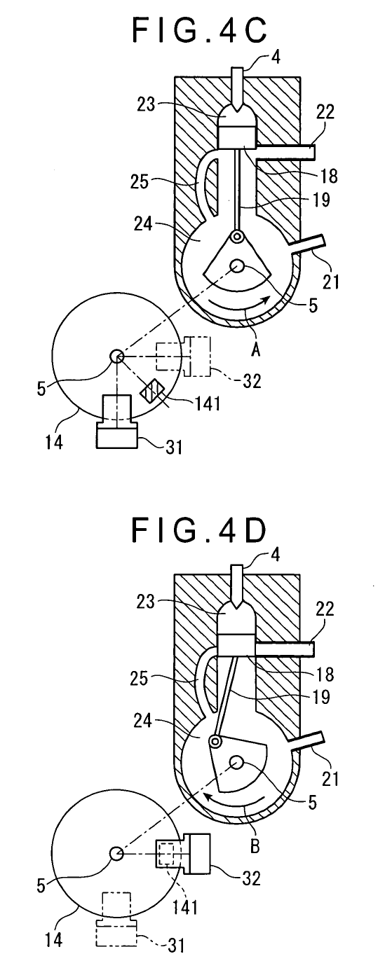

Next, operation of the two-stroke engine according to the exemplary embodiment will be described below with reference to FIGS. 4A to 4D.

FIGS. 4A to 4D schematically illustrate an interior structure of the engine body 1 (hereinafter referred to as an engine inside). FIGS. 4A to 4D illustrate the engine inside, respectively when the piston is positioned on the bottom dead center, when the ignition timing is appropriate in the normal rotation, when the piston is positioned on the top dead center, and when the ignition timing is appropriate in the reverse rotation.

A piston 18 is slidably inserted into the cylinder 2. One end of a connecting rod 19 is rotatably connected to the piston 18 and the other end of the connecting rod 19 is rotatably connected to the crankshaft 5. One end of the crankshaft 5 is rotatably supported by a bearing (not shown) of the crankcase 3 and is exposed to the outside of the crankcase 3. The above-described propeller hub 13 is attached to the exposed portion of the crankshaft 5.

With such an arrangement, an upward and downward movement of the piston 18 is converted into a rotational movement of the crankshaft 5 through the connecting rod 19, and the propeller hub 13 is rotated synchronously with the rotation of the crankshaft 5. Further, the flange 14 is rotated synchronously with the rotation of the propeller hub 13, and then the permanent magnet 141 is rotated together with the flange 14.

The cylinder 2 includes an intake port 21 that communicates with the carburetor 7 through the insulator 6 and an exhaust port 22 that communicates with the muffler 8.

The engine inside includes a cylinder chamber 23 formed in an upper portion of the piston 18, a crank chamber 24 formed in a lower portion of the piston 18, and a scavenging passage 25 that communicates with the cylinder chamber 23 and the crank chamber 24.

Operation of the engine during the normal rotation (arrow A) according to the exemplary embodiment will be described below with reference to FIGS. 4A to 4C. At this time, the magnetic sensor 9 is attached to the normal-rotation sensor attachment 31 for enabling the magnetic sensor 9 to detect the appropriate ignition timing when the two-stroke engine is normally rotated.

As the engine is operated in a cycling manner, the operation of the engine will be described with the bottom dead center of the piston 18 (FIG. 4A) being exemplarily set as a starting point.

Firstly, when the piston 18 ascends from the bottom dead center (FIG. 4A) by the rotation of the engine, a pressure in the crank chamber 24 is lowered while a pressure in the cylinder chamber 23 is raised, and the scavenging passage 25 and the exhaust port 22 having been open in the cylinder chamber 23 are sequentially closed. Since the pressure in the crank chamber 24 is lowered, air-fuel mixture mixed in the carburetor 7 is fed into the crank chamber 24 from the intake port 21 through the insulator 6.

When the piston 18 further ascends to reach such a position below the top dead center that a rotation angle of the crankshaft 5 becomes 45 degrees (FIG. 4B), which corresponds to the appropriate ignition timing, the magnetic sensor 9 detects the permanent magnet 141. Then, the ignition module 16 receives a detection signal from the magnetic sensor 9, and cause a discharge on the ignition plug 4 by the buttery 17 in accordance with the received detection signal to ignite the air-fuel mixture in the cylinder chamber 23.

At this time, the piston 18 continues to ascend due to inertial force of the engine rotation and reaches the top dead center (FIG. 4C). Subsequently, when the piston 18 starts to descend due to explosive force of the air-fuel mixture, the pressure in the crank chamber 24 is raised because a check valve (not shown) is provided on the intake port 21.

When the piston 18 further descends, the exhaust port 22 and the scavenging passage 25 are sequentially opened in the cylinder chamber 23. The burned air-fuel mixture is exhausted from the exhaust port 22 while the air-fuel mixture in the crank chamber 24 is fed thereinto from the scavenging passage 25 to scavenge the burned air-fuel mixture residing in the cylinder chamber 23 through the exhaust port 22.

Then, due to the inertial force of the engine rotation, the piston 18 starts to ascend again after reaching the bottom dead center. Therefore, the pressure in the crank chamber 24 is lowered while the scavenging passage 25 and exhaust port 22 are sequentially closed. A series of the above-described movements are repeated.

On the other hand, during the reverse rotation (arrow B) of the engine according to the exemplary embodiment, the magnetic sensor 9 is attached to the reverse-rotation sensor attachment 32 as shown in FIG. 3. With this arrangement, when the piston 18 reaches such a position that the rotation angle of the crankshaft 5 becomes, for example, 45 degrees (FIG. 4D), which corresponds to the appropriate ignition timing, the magnetic sensor 9 detects the permanent magnet 141. In other wards, in the reverse rotation (arrow B), the engine according to the exemplary embodiment works in the same manner as in the normal rotation (arrow A).

By changing a position of the magnetic sensor 9 in accordance with a rotational direction of the engine, the engine having common components can be made capable of working in the same manner in both of the normal rotation and the reverse rotation. In other words, in both of the normal rotation and the reverse rotation, a discharge can be caused on the ignition plug at a predetermined timing before the piston reaches the top dead center.

The invention is not limited to the exemplary embodiment described above, but includes other arrangements as long as an object of the invention can be achieved, which includes the following modifications.

For example, although the rotor is defined by the flange 14 according to the exemplary embodiment, the rotor may be the propeller hub 13 itself, the crankshaft 5 itself, or a component separately attached to the crankshaft 5. In short, the rotor may be any portion that rotates in synchronization with the rotation of the engine.

However, the above-described advantages will be attained with the arrangement according to the exemplary embodiment.

The exemplary embodiment can also provide the above-described advantages even when the arrangement is modified as in the following modifications.

For example, although the ignition timing controller for igniting the ignition plug 4 is provided by the ignition module 16 and the buttery 17, the ignition coil may be used in place of the ignition module 16 and the buttery 17. Any arrangements capable of controlling the ignition timing may be employed.

Although the appropriate ignition timing is when the rotation angle of the crankshaft 5 becomes 45 degrees before the piston reaches the top dead center according to the exemplary embodiment, the appropriate ignition timing does not have to strictly correspond to the timing at which the rotation angle becomes 45 degrees, depending on an arrangement of the engine. Any rotation angle may be selected as long as the engine can continue to rotate.

In the exemplary embodiment, the sensor attachment 31 and 32 disposed at the two positions respectively: the position at the lower side of the crankcase 3 when the engine body 1 is disposed with the cylinder 2 being positioned at the upper side; and the position adjacent to the lateral of the crankcase 3 and spaced apart from the muffler 8. However, the above-described two positions of the sensor attachments 31 and 32 may be other positions as long as the sensor attachments 31 and 32 are provided adjacent to the engine body 1. The sensor attachments 31 and 32 may be provided on a side to which the two-stroke engine is attached, for example, adjacent to a body of the radio-controlled aircraft. However, this arrangement is not practical because the sensor attachment is required to be provided in such a position as to enable the magnetic sensor 9 to detect appropriate ignition timings during both of the normal and reverse rotations.

Although the detected unit for detecting the rotational position is defined by the permanent magnet 141 and the sensor is defined by the magnetic sensor 9 according to the exemplary embodiment, the detected unit and the sensor may be respectively defined by a light source and an optical sensor. Any arrangements capable of detecting the rotation angle of the crankshaft 5 may be employed.

Although the flange 14 has the hole on the lateral opposite to the engine body 1 and the permanent magnet 141 is fixed to the hole by an adhesive or the like according to the exemplary embodiment, the permanent magnet 141 may be fixed by a bolt or in any other manner. Further, the permanent magnet 141 may be fixed to an outer circumference of the flange 14 or the like as long as the permanent magnet 141 is detectable by the magnetic sensor 9.

### INDUSTRIAL APPLICABILITY

The invention is applicable to a two-stroke engine rotatable in both of a normal rotational direction and a reverse rotational direction, particularly to a two-stroke engine for hobby.

1. A two-stroke engine, comprising:
a detected unit for detecting a rotational position that is provided on a rotor that rotates synchronously with a rotation of the engine;
a sensor that is attached adjacent to an engine body and adapted to detect the detected unit for detecting the rotational position; and
an ignition timing controller that receives a detection signal from the sensor and transmits an ignition signal to an ignition plug, wherein
the detected unit for detecting the rotational position is provided at a single position of the rotor,
sensor attachments are provided at two positions adjacent to the engine body, and
the sensor is attached to one of the sensor attachments.

2. The two-stroke engine according to claim 1, wherein
the sensor attachments adjacent to the engine body are respectively positioned at a position at which an appropriate ignition timing when the engine is rotated in a predetermined direction is detectable by the sensor and at a position at which an appropriate ignition timing when the engine is rotated in a reverse direction of the predetermined direction is detectable by the sensor.

3. The two-stroke engine according to claim 1, wherein
the sensor attachments adjacent to the engine body are respectively positioned at a lower side of a crankcase provided to the engine when the engine body is disposed such that a cylinder is positioned on an upper side, and adjacent to a lateral of the crankcase and spaced apart from a muffler.

4. The two-stroke engine according to claim 1, wherein
the detected unit for detecting the rotational position is provided by a permanent magnet, and the sensor is provided by a magnetic sensor.

5. The two-stroke engine according to claim 1, wherein
the detected unit for detecting the rotational position is attached to a lateral of the rotor, the lateral opposing to the engine body.
